(19) United States
(12) Patent Application Publication
(10) Pub. No.: US 2025/0378602 A1
(43) Pub. Date: Dec. 11, 2025

(54) AI-DRIVEN CREATION OF CUSTOM STICKERS FROM MESSAGES IN CHAT INTERFACES

(71) Applicant: Snap Inc., Santa Monica, CA (US)

(72) Inventor: Nathan Kenneth Boyd, Los Angeles, CA (US)

(21) Appl. No.: 18/737,529

(22) Filed: Jun. 7, 2024

(51) Int. Cl. G06T 11/60; G06F 3/0482; G06F 40/20; H04L 51/066; H04L 51/10

(52) U.S. Cl. CPC G06T 11/60; G06F 3/0482; G06F 40/20; H04L 51/066; H04L 51/10; G06T 2200/24

(57) ABSTRACT

This disclosure relates to techniques for generating and utilizing custom stickers in a digital communication environment. A technique involves receiving a text-based message input during a chat session and using a generative language model (e.g., a Large Language Model, or LLM) to create a text prompt. This prompt is then used by a generative image model to produce a custom sticker. The generated sticker is sent to a client device where it is displayed in a sticker tray alongside other selectable stickers. Users can select and send these stickers directly within their chat interface, enriching communication with visually expressive and contextually relevant imagery.

### TECHNICAL FIELD

The present application pertains to the field of artificial intelligence (AI) and interactive digital communication platforms. More specifically, a first portion of the subject matter of the present application relates to techniques for generating custom stickers based on text-based messages that are input during chat sessions. Additionally, a second portion of the subject matter presented herein involves advanced methodologies for automatically generating creative captions to be used with custom images or stickers, utilizing image analysis and natural language processing models to interpret and enhance visual content with contextually relevant textual annotations.

### BACKGROUND

In recent years, the proliferation of social media platforms and mobile applications has significantly transformed the way individuals communicate and interact. These digital platforms have become integral to daily social interactions, providing users with a myriad of ways to connect, share, and express themselves. Among the various features offered by these platforms, chat-based messaging has emerged as a cornerstone of digital communication.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a diagram illustrating an example of an interaction system as part of a networked environment in which various instances of the techniques set forth herein may be deployed.

FIG. 2 is a block diagram illustrating further details of the interaction system, consistent with some examples.

FIG. 3 is a diagram illustrating a detailed view of a custom sticker system, consistent with some examples.

FIG. 4 is a flow diagram illustrating operations performed by a custom sticker system, as part of a method for generating a custom sticker, according to some examples.

FIGS. 5 through 11 show various user interfaces for a chat or messaging application, from which one can invoke the creation of a custom sticker, and share a custom sticker, according to some examples.

FIG. 12 is a diagram illustrating a detailed view of a custom sticker system that leverages generative machine learning models for generating custom captions, consistent with some examples.

FIG. 13 is a flow diagram illustrating operations performed by a custom sticker system, as part of a method for generating a custom sticker with custom caption, according to some examples.

FIGS. 14 through 17 show various user interfaces for a chat or messaging application, from which one can invoke the creation of a custom sticker with custom caption, and share a custom sticker, according to some examples.

FIG. 18 is a diagrammatic representation of a machine in the form of a computer system within which a set of instructions may be executed to cause the machine to perform any one or more of the methodologies discussed herein, according to some examples.

FIG. 19 is a block diagram showing a software architecture within which examples may be implemented.

### DETAILED DESCRIPTION

Presented herein are innovative techniques for enhancing user interaction within digital communication platforms through the generation of custom stickers and custom creative captions. The subject matter described herein includes techniques for dynamically creating custom stickers based on textual inputs, such as messages entered via a chat interface, and separate techniques for generating engaging captions to further enhance images and customer stickers. These techniques utilize advanced image analysis and natural language processing models to interpret the content of the text and images, thereby facilitating the creation of visually compelling and contextually appropriate digital interactions. These approaches significantly enrich the user experience by allowing personalized and contextually relevant visual content to be seamlessly integrated into chat sessions. In the following description, for purposes of explanation, numerous specific details are set forth to provide a thorough understanding of the various aspects of the described techniques. It will be evident, however, to one skilled in the art, that these techniques may be practiced without all of these specific details.

In recent years, the proliferation of social media platforms and mobile applications has significantly transformed the way individuals communicate and interact. These digital platforms have become integral to daily social interactions, providing users with a myriad of ways to connect, share, and express themselves. Among the various features offered by these platforms, chat-based messaging has emerged as a cornerstone of digital communication.

Chat-based messaging allows users to exchange text messages in real-time, fostering a sense of immediacy and connectivity that mirrors face-to-face conversations. Over time, the scope of chat functionalities has expanded beyond simple text exchanges. Modern messaging platforms now support a rich array of multimedia content, including images, videos, emojis, and stickers. This multimedia integration caters to the diverse expressive needs of users, enabling them to convey emotions, reactions, and nuances that text alone might not fully capture.

Stickers, in particular, have gained immense popularity in digital communications. These graphical images serve as a dynamic form of expression that adds a playful and visually engaging element to conversations. Stickers can reflect a wide range of emotions and concepts, from joy and affection to humor and sarcasm, making them a versatile tool in the arsenal of digital communication.

Alongside the rise of stickers, the advent of image editing tools within chat platforms has further revolutionized digital communication. These tools often allow users to add custom captions directly to images, enabling the creation of personalized memes that can quickly capture the cultural zeitgeist and spread virally across social networks. This capability not only enhances the user's ability to convey more complex and nuanced messages but also taps into the broader social phenomena of meme culture, where humor, satire, and commentary are encapsulated in visually compelling formats. The ability to swiftly create and share such content empowers users to participate in broader dialogues, shaping trends and public discourse in real-time. This trend towards interactive and meme-centric communication underscores a shift towards more engaging and community-oriented digital interactions, where users are not just consumers of content but active creators and distributors within their social spheres.

The evolution of chat-based messaging into a multimedia-rich environment reflects broader trends in digital media consumption. Users increasingly seek interactive and personalized experiences that allow them to express their individuality and creativity. As a result, social media platforms and messaging apps continually innovate to provide new features and enhancements that enrich user interactions and foster deeper connections within the digital landscape.

Despite the popularity and utility of stickers in digital communication, a significant challenge remains in the creation of custom stickers that are both contextually relevant and personalized to the user's current conversation. Traditional sticker sets are static and limited, often failing to fully capture the nuances of real-time conversations or the specific emotions users wish to convey. This limitation can hinder the depth of expression and engagement in chat interactions, as users are forced to rely on a pre-defined selection of images that may not accurately reflect their intended message or emotional state.

Furthermore, while the availability of image editing tools within chat platforms has introduced new possibilities for customization, these tools often present practical challenges, particularly when used on mobile devices. The interfaces of such editing tools can be cumbersome, requiring multiple steps and adjustments that may not be intuitive for all users. Additionally, the process of creating a custom sticker using these tools can be time-consuming. In the fast-paced environment of instant chat-based messaging, where conversations flow quickly and dynamically, the delay introduced by manual sticker customization can disrupt the natural rhythm of communication. This lag in response time detracts from the immediacy that is characteristic of digital chats, potentially diminishing the user's ability to engage effectively and timely with their contacts.

Described herein are various improved techniques for generating customer stickers and custom captions, in the context of a digital communications environment. The first technique addresses some of the several aforementioned problems by dynamically generating custom stickers based on textual inputs from chat messages. This approach leverages advanced natural language processing models to interpret the text within a chat, allowing the system to create stickers that are uniquely tailored to the context and content of the conversation. By generating stickers that are directly relevant to the ongoing discussion, this technique enhances the expressiveness and personalization of digital communication, enabling users to convey their thoughts and emotions more effectively and engagingly.

On the other hand, while users enjoy the ability to modify images with captions, creating engaging and contextually appropriate captions manually can be challenging and time-consuming. Users may struggle to come up with witty or fitting captions on the spot, which can diminish the impact and shareability of their customized content. Additionally, the manual process of captioning can interrupt the flow of communication, particularly in fast-paced chat environments.

A second technique set forth herein addresses these issues by automating the generation of creative captions for images within chat interfaces. Utilizing image analysis models to understand the content and context of the image, coupled with generative language models to produce captions, this method streamlines the process of enhancing images with text. By automatically generating a selection of suitable captions that users can quickly choose from, this technique not only saves time but also enhances the quality and relevance of the captions. This automation supports a more fluid and engaging user experience, encouraging greater interaction and creativity in the use of images in digital communication.

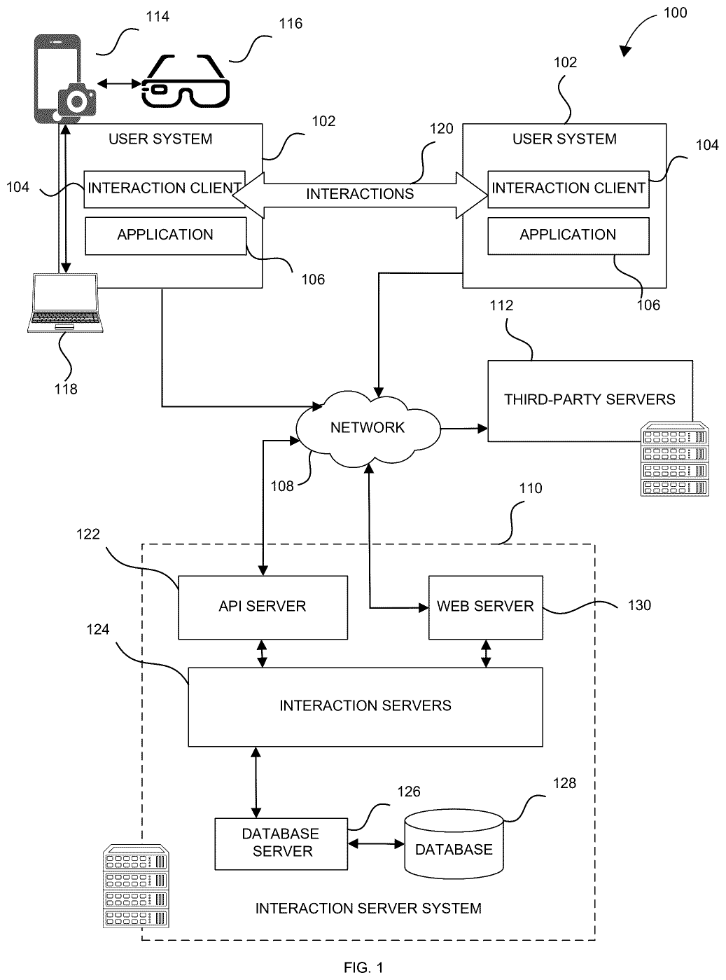

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

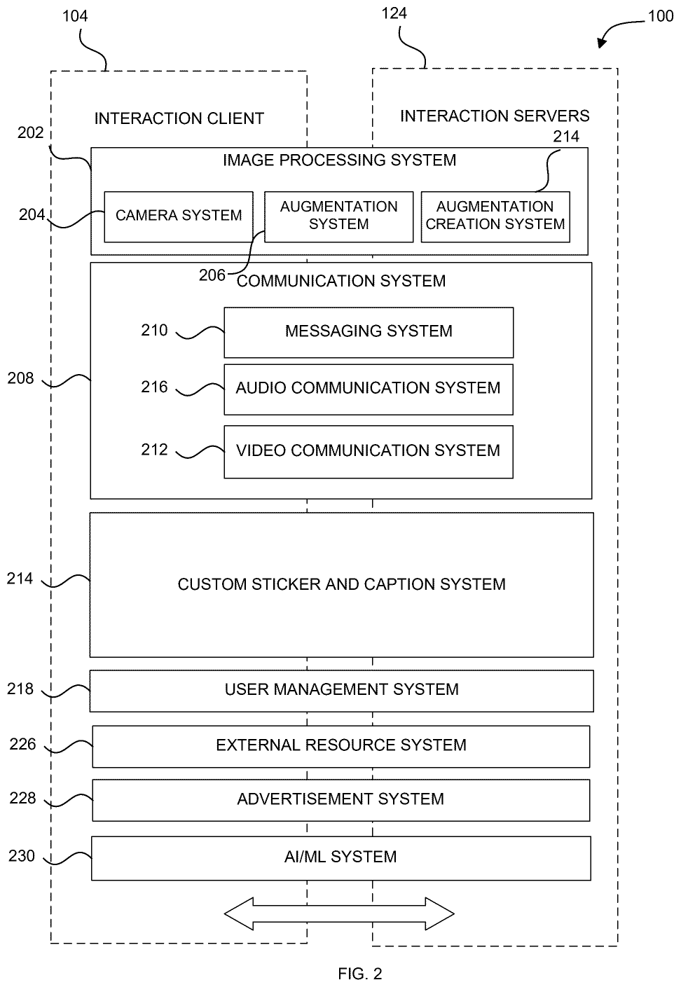

The interaction servers 124 host multiple systems and subsystems, described below with reference to FIG. 2.

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving from a third-party server 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 502 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

The custom sticker and caption system 214 is an integral component of the interaction system 100, designed to enhance user engagement by allowing the creation of personalized stickers and captions within a digital communication environment. This system leverages advanced artificial intelligence and machine learning technologies to provide a seamless and interactive user experience.

The custom sticker and caption system 214 utilizes input from users—such as text messages or images—to dynamically generate stickers and captions that are contextually relevant and visually appealing. For instance, when a user inputs a text message, the system can generate a custom sticker that visually represents the message's sentiment or content. Similarly, when a user selects an image, the system can automatically generate a fitting caption that complements the image, enhancing the overall communicative value.

The operation of the custom sticker and caption system 214 is reliant on the artificial intelligence and machine learning system 230. This dependency is manifested in several key functionalities. Firstly, the AI/ML system 230 analyzes the input data (text or images) to understand its context and significance. This analysis involves natural language processing for text inputs and image recognition technologies for image inputs, enabling the system to grasp the underlying themes or emotions associated with the data.

Once the initial analysis is complete, the AI/ML system 230 generates prompts based on the understood context. These prompts are then used to guide the generative models within the custom sticker and caption system 214. For text-based inputs, the system generates visual representations or stickers that align with the text's sentiment. For image-based inputs, the system creates captions that are not only contextually appropriate but also engaging, adding a layer of interaction to the user's media.

The integration between the custom sticker and caption system 214 and the AI/ML system 230 is further exemplified in the continuous feedback loop that allows for the refinement of outputs. The AI/ML system 230 can learn from user interactions and preferences, which in turn informs the generative models to produce more accurate and appealing stickers and captions over time.

Moreover, the custom sticker and caption system 214 is designed to work in harmony with other subsystems within the interaction system 100. It interacts with the communication system 208 to ensure that the generated stickers and captions can be easily shared and displayed across various communication channels, such as chat interfaces or social media platforms. This integration ensures that users can seamlessly use the custom stickers and captions in their regular communications, enhancing the expressiveness and dynamism of digital interactions.

A user management system 218 is operationally responsible for the management of user data and profiles, and maintains entity information (e.g., stored in entity tables 308, entity graphs 310 and profile data 302) regarding users and relationships between users of the interaction system 100.

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

The artificial intelligence and machine learning (AI/ML) system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The AI/ML system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

In some examples, the AI/ML system 230, a sub-system of the interaction system 100, employs a suite of sophisticated models tailored to enhance the functionality of the custom sticker and caption system 214. These models are designed to process and interpret a wide range of data inputs, from textual content to visual media, enabling the dynamic creation of personalized digital content that enhances user interaction and communication.

The AI/ML system 230, integral to the interaction system 100, utilizes a combination of models specifically designed to enhance the custom sticker and caption system 214. These models adeptly process and interpret a range of data inputs, from textual content to visual media, enabling the dynamic creation of personalized digital content that significantly enhances user interaction and communication.

In some examples, Natural Language Processing (NLP) models are employed to understand and process textual inputs within the system. They analyze text to detect sentiment, extract key phrases, and comprehend the context or theme of conversations. This analysis assists in generating text-based prompts that guide the creation of stickers and captions that are contextually relevant to the ongoing conversation. Concurrently, image recognition and processing models analyze visual inputs to detect objects, facial expressions, and scenes within images. These models, which utilize advanced techniques such as convolutional neural networks (CNNs), are essential for the automatic generation of captions by understanding the content and context of images.

Generative models, including Generative Adversarial Networks (GANs) and Variational Autoencoders (VAEs), are used to generate visually appealing stickers and captions. By integrating inputs from NLP and image recognition models, these generative models produce creative and contextually appropriate visual content. They are meticulously trained on a diverse dataset to ensure a broad range of creative outputs.

In some examples, the workflow integrates these models effectively. When a user inputs text or uploads an image, the NLP models first process the text to understand its sentiment and thematic elements, while image recognition models analyze any uploaded images to identify key visual elements. Insights from these models are then fed into the generative models, which create stickers that visually represent the text's sentiment or themes for text inputs, and generate captions that complement the visual content for image inputs. The outputs from the generative models are refined and adjusted to ensure they meet the platform's standards for quality and appropriateness, utilizing additional filtering and enhancement algorithms if necessary.

This system significantly enhances user interaction by automating the creative process, allowing users to quickly create personalized and contextually relevant stickers and captions without needing extensive design skills or effort. This functionality not only enriches the user experience but also drives engagement by enabling users to express themselves more effectively in digital communications. Through the use of advanced NLP, image recognition, and generative models, the system offers a seamless and enriched interactive experience that enhances digital communication across the platform.

The implementation of the AI/ML system 230 within the interaction system 100 is versatile, accommodating various operational environments to optimize performance and efficiency. In some instances, the models are hosted locally on user devices. This local deployment leverages the device's computational power to process data directly on the device, enhancing privacy and reducing latency, which is particularly crucial for real-time applications such as live image processing and instant messaging enhancements. On the other hand, for more complex operations that require extensive computational resources or for features that benefit from continually updated algorithms, one or more models may be remotely accessed over a network. This remote access is typically facilitated through APIs that connect the back-end servers (e.g., interation servers 124) with powerful server-based AI models hosted in the cloud. This setup allows for the leveraging of advanced processing capabilities and the utilization of large-scale machine learning models that can be updated dynamically without requiring changes to the back-end servers and client-side application. Such a hybrid approach, employing both local and remote model implementations, ensures that the system remains both powerful and agile, capable of providing advanced AI-driven features while maintaining responsiveness and user privacy.

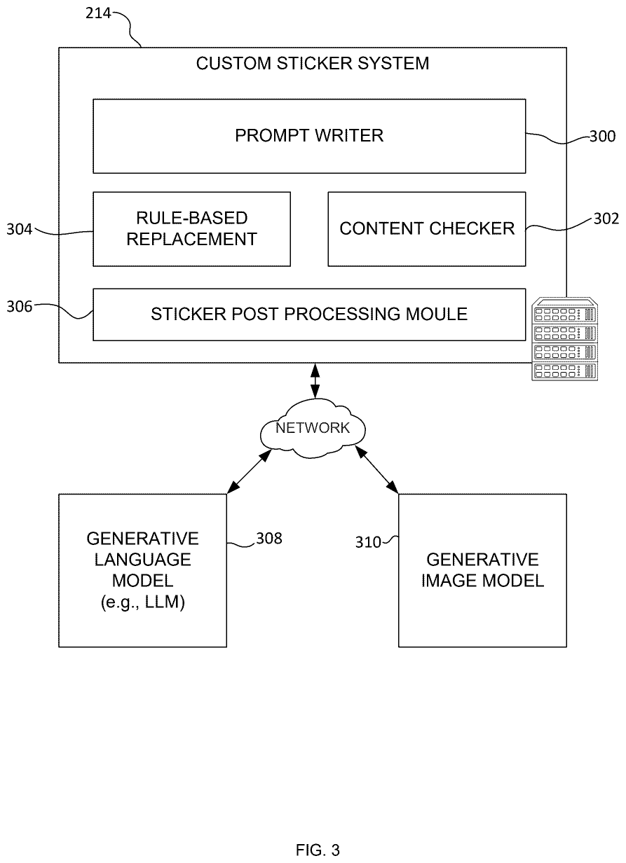

FIG. 3 is a diagram illustrating a detailed view of a custom sticker system 214, consistent with some examples, and providing a visual representation of the various components and their interactions within the custom sticker system 214 designed to generate custom stickers based on textual inputs from a chat interface. As illustrated in FIG. 3, the custom sticker system 214 includes a prompt writer 300. The prompt writer 300 is responsible for dynamically generating a prompt based on the textual input received from a user. In some examples, this is achieved by utilizing a predefined prompt template, which structures the input text (e.g., a chat message) in a way that is optimized for processing by a generative language model, such as a Large Language Model (LLM). The prompt template includes specific instructions that guide the generative language model on how to interpret the text and what type of visual content is expected as a final output.

Once the prompt writer 300 has formatted the input text according to the prompt template, the generated prompt is forwarded to the generative language model 308, shown in FIG. 3 to be a component of the AI/ML system 214. This model, which may be an LLM, processes the LLM prompt, as an input, to generate as output a textual description of a sticker that visually represents the themes or emotions expressed in the input text (e.g., the chat message, as received from the user system or client device). This sticker description is crafted to be both contextually relevant to the conversation and visually engaging.

The output from the generative language model 308, consisting of a detailed textual description of the proposed sticker, undergoes further processing to generate a second, refined prompt. This second prompt, crafted to encapsulate the nuances and specific visual elements described in the initial output, is then provided to the generative image model 310. This model, leveraging advanced artificial intelligence (AI) techniques such as neural networks or adversarial models, interprets the refined prompt to create an actual image file. The resulting image is a high-quality visual representation of the sticker, generated to align closely with the detailed specifications provided in the second prompt. This process ensures that the final sticker not only captures the essence of the user's input but also adheres to the aesthetic and thematic expectations set forth in the textual description.

Additionally, the custom sticker system 214 includes a content checker 302, which ensures that both the input text and the generated sticker description adhere to predefined content guidelines. The content checker 302 scans the text for any objectionable content or phrases that should not be processed or depicted in the sticker. If such content is detected, the system can halt the process and prevent the generation of inappropriate stickers.

The sticker post processing module 306 is responsible for applying final adjustments to the generated sticker image. This may include resizing, cropping, or adding additional graphical elements to enhance the visual appeal of the sticker. Once the sticker has been finalized, it can be sent back to the user's device and displayed within the chat interface, allowing the user to incorporate it into their conversation seamlessly.

Following the content check, the custom sticker system 214 incorporates a rule-based replacement component 304, which plays a role in refining the text used for sticker generation. This component is equipped with a set of predefined rules designed to automatically replace specific words or phrases identified in the text with more appropriate alternatives. This process not only helps in adhering to the content guidelines but also enhances the quality of the textual input for generating the sticker. By modifying the text in this manner, the rule-based replacement component 304 ensures that the descriptions fed into the generative models are not only suitable but also optimized for producing visually appealing and contextually relevant stickers. This step allows for maintaining the integrity and appropriateness of the stickers generated, contributing to a user-friendly and respectful digital communication environment.

Overall, FIG. 3 illustrates a comprehensive system designed to automate and enhance the creation of custom stickers in digital communication platforms, leveraging advanced AI technologies to interpret textual inputs and generate corresponding visual content that enriches user interactions.

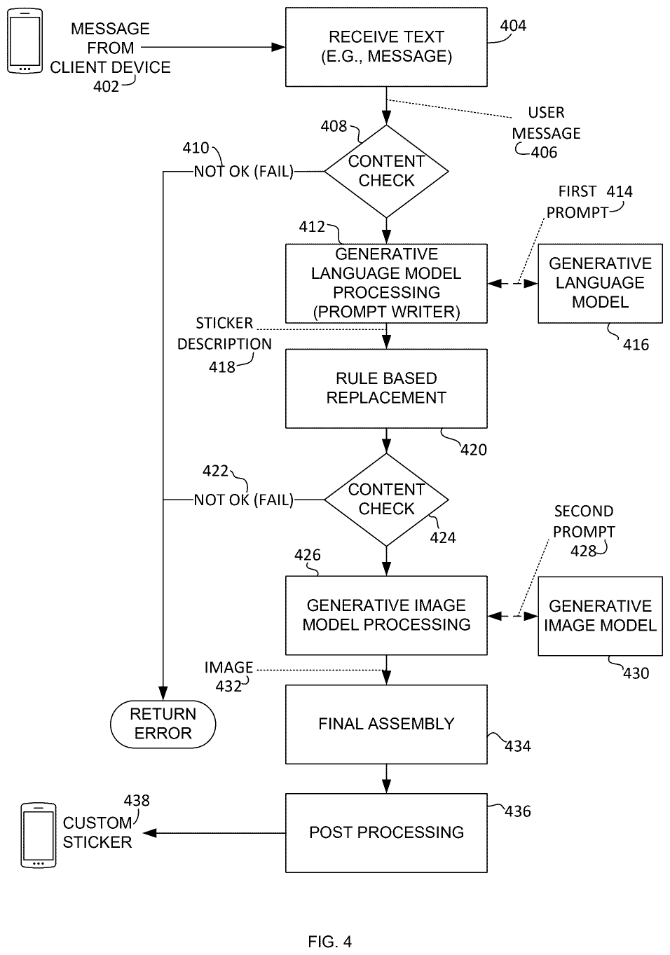

FIG. 4 is a flow diagram illustrating operations performed by a custom sticker system 214, as part of a method for generating a custom sticker, according to some examples. This diagram details the sequential steps involved in processing user input from a chat application to generate a custom sticker, highlighting the integration of content checking and generative models to ensure both appropriateness and relevance of the generated stickers. It should be noted that the specific method illustrated is one example of implementation; those skilled in the art will recognize that the order of operations may vary and certain steps may be optionally excluded or modified, consistent with different embodiments, without departing from the scope of the technology.

In a typical use scenario, a user engages with a chat application where they can communicate with others through text-based chat messages. As part of this interaction, the user may decide to express a thought or emotion more vividly by using a custom sticker. The user enters their desired text into a message input field provided within the chat interface. This text could range from a simple greeting or reaction to a more complex sentence expressing feelings or actions.

At step 404 in FIG. 4, the text-based message 402 entered by the user is received from the client device. This is the initial interaction point with the custom sticker system 214, where the raw user input is captured for further processing. The received text-based message, referred to as the “user message” 406, forms the basis for generating a contextually relevant sticker.

Once the user message is received, it is then provided as input to a content checker at step 408. The content checker analyzes the text of the message to ensure that the text adheres to predefined guidelines and is free from objectionable or inappropriate content. This step maintains the integrity and appropriateness of the communication within the chat application. In some examples, the content checker scans the text against a database or a list of flagged words, phrases, or patterns that are considered inappropriate or not suitable for visual representation in a sticker format.

If the content checker identifies any problematic elements within the text, at step 410, labeled as “NOT OK (FAIL)”, the process is halted, and an error message or notification may be returned to the user, indicating that the text cannot be used to generate a sticker. This safeguard ensures that only appropriate content progresses through the system, aligning with community standards and platform policies.

Conversely, if the text passes the content check 408, indicating no objectionable content is found (“OK”), the process moves forward to the next stages of sticker generation, which involve more advanced generative models. The successful content check greenlights the user's input for creative and visual enhancement through AI-driven sticker generation processes, which are detailed in subsequent steps of the flow diagram.

Following the successful content check, the process advances to step 412 where the prompt writer component comes into play. Utilizing a predefined prompt template, the prompt writer crafts a first prompt 414 that is specifically designed to guide the generative language model 416 in creating a relevant and engaging text-based sticker description. This prompt includes key elements from the user's approved message, and may be enriched with additional directives or stylistic suggestions to align the output closely with the intended emotional or thematic expression. The prompt may also specify certain constraints or themes to ensure the sticker remains appropriate and engaging within the context of the conversation.

The first prompt 414 is then provided to the generative language model 416, which may be accessed over a network. This model, often a sophisticated AI system like an LLM, processes the prompt to generate a textual description of the proposed sticker. The generative language model 416 operates by interpreting the input prompt, drawing on extensive pre-trained data and contextual understanding to produce a creative and contextually relevant output. This output essentially serves as a detailed conceptual blueprint for the visual representation of the sticker, encapsulating both the essence of the original user message and the creative flair introduced by the prompt writer.

The interaction with the generative language model 416 is typically conducted via secure network communications, ensuring that the data exchanged between the custom sticker system and the model remains confidential and integral. This setup allows for the leveraging of powerful cloud-based AI capabilities, which can process complex prompts and generate high-quality outputs efficiently, thereby enhancing the overall functionality and responsiveness of the custom sticker system.

After the generative language model 416 produces a sticker description, this output is then directed to the rule-based replacement component 420 for refinement and to ensure the appropriateness of the content before it is visually represented. The text-based sticker description, which encapsulates the conceptual blueprint for the sticker, contains various elements that might need adjustment to align with community standards or the specific stylistic guidelines of the platform.

At step 420, the rule-based replacement component processes the sticker description against a set of predefined rules. These rules are designed to identify and modify specific words or phrases within the description that may be deemed inappropriate, sensitive, or not in line with the desired tone and style. The component systematically scans the text, applying these rules to substitute undesirable terms with more suitable alternatives. This could involve replacing slang or colloquialisms with more universally understood terms, adjusting potentially offensive language, or refining the descriptive language to better suit the visual style of the stickers.

The operation of the rule-based replacement component maintains the quality and appropriateness of the stickers generated. By ensuring that the descriptions used to create visual content are aligned with user expectations and platform policies, the custom sticker system upholds a high standard of communication within the chat application. This step not only enhances the user experience by providing more engaging and suitable stickers but also helps in safeguarding the platform against the risks associated with generating user-driven content.

Following the rule-based replacement process, the sticker description undergoes a second content check at step 424, which serves as an additional safeguard to ensure the integrity and appropriateness of the content before it progresses further in the sticker generation process. This second content check mirrors the initial content screening, scanning the revised sticker description for any newly introduced objectionable words or phrases that might have been generated by the generative language model. This review ensures that the content adheres strictly to the platform's community standards and regulatory requirements. Only after confirming that the sticker description is free of any inappropriate content does the system allow the description to advance to the next step, where it is used to generate the visual representation of the sticker. This layered approach to content checking underscores the platform's commitment to maintaining a safe and positive environment for all users.

After successfully passing the second content check, the process moves to step 426, where a second prompt, designated as the second prompt 428, is prepared for use with the generative image model 430. In some examples, this second prompt 428 is crafted using a predefined template that structures the sticker description into a format optimized for image generation. The template ensures that the second prompt includes all necessary descriptive elements that convey the visual specifics needed to accurately represent the sticker, while also providing the model with guidance on specifics of the format desired as output. This might include details about colors, actions, emotions, or any other visual cues that are essential for creating an image that aligns with the user's original message.

The generative image model 430, which may be hosted on a server, is accessible via a network, allowing for robust scalability and maintenance of the model. This setup ensures that updates and improvements to the model can be deployed efficiently without disrupting the user experience. The model is specifically trained to interpret textual prompts and generate corresponding image files. It utilizes advanced machine learning techniques, possibly including neural networks or other forms of artificial intelligence, to translate the text descriptions into rich, detailed images that visually depict the described scenes or concepts.

Several types of advanced machine learning models could serve as the generative image model 430, each offering unique capabilities for transforming textual descriptions into vivid images. One potential model is a Generative Adversarial Network (GAN), which effectively generates high-quality images through its dual-network architecture involving a generator and a discriminator that refine each other's outputs. Another option could be Variational Autoencoders (VAEs), which are proficient in generating images by learning the distribution of data and sampling from this distribution to produce new items.

Transformer-based models, such as DALL-E or Imagen, represent another cutting-edge choice. These models leverage the transformer architecture's ability to handle sequential data, making them exceptionally good at understanding and generating complex images from detailed textual prompts. Additionally, Conditional Convolutional Neural Networks (CNNs) could be employed, which excel in image generation tasks by conditioning the generation process on specific input features, such as the text descriptions in this scenario.

Each model type brings strengths that could be strategically chosen based on the specific requirements of the sticker generation system. For instance, GANs might be preferred for their ability to produce photorealistic images, while transformer-based models could be advantageous for their deep understanding of text and context. VAEs offer robustness in handling various data distributions, and Conditional CNNs provide focused generation based on given conditions. The selection of a particular model would depend on factors such as the desired fidelity of the images, the complexity of the text inputs, computational efficiency, and the ability to scale as user demand increases.

By feeding the carefully crafted prompt into the generative image model, the system leverages the model's trained capabilities to produce an image file that visually encapsulates the essence of the user's input. This image generation step is crucial as it transforms textual content into a visual format, enhancing the communicative value of the sticker by making it both engaging and relevant to the chat conversation. The integration of this advanced AI-driven process ensures that the stickers are not only contextually appropriate but also visually compelling, thereby enriching the user's interaction within the digital communication platform.

After the generative image model 430 produces the image file 432, the process advances to the final assembly step 434. In this step, the image file undergoes a series of enhancements and modifications to prepare it for delivery to the user. Final assembly may involve adding additional graphical elements such as borders or shadows, adjusting the image size and resolution to suit different device displays, and embedding any necessary metadata into the file. This step ensures that the sticker not only meets the aesthetic and thematic expectations set by the user's input but is also optimized for performance and appearance across various platforms and devices.

Once the sticker has been fully assembled, it moves to the post-processing step 436, where it is prepared for transmission to the user system or client device from which the initial request originated. In some embodiments, the image file representing the sticker may be stored temporarily on a server. In such cases, a link to the sticker file may be generated and sent to the client device, allowing the user to access and download the sticker directly from the server. This method can be particularly useful for reducing bandwidth usage on the client side and facilitating quicker access to the sticker across multiple devices.

Alternatively, the sticker may be sent directly to the client device as part of the response to the initial request. This approach ensures that the sticker is immediately available for use within the user's chat application, enhancing the interactive experience. The direct transmission method might involve encoding the image file in a suitable format and sending it over a secure connection to ensure data integrity and privacy.

Regardless of the method used, the goal of the post-processing step is to deliver the sticker in a manner that is both efficient and user-friendly, ensuring that users can quickly and easily integrate the newly created stickers into their communications without noticeable delays or complications. This seamless integration is key to maintaining an engaging and responsive user experience within the chat application.

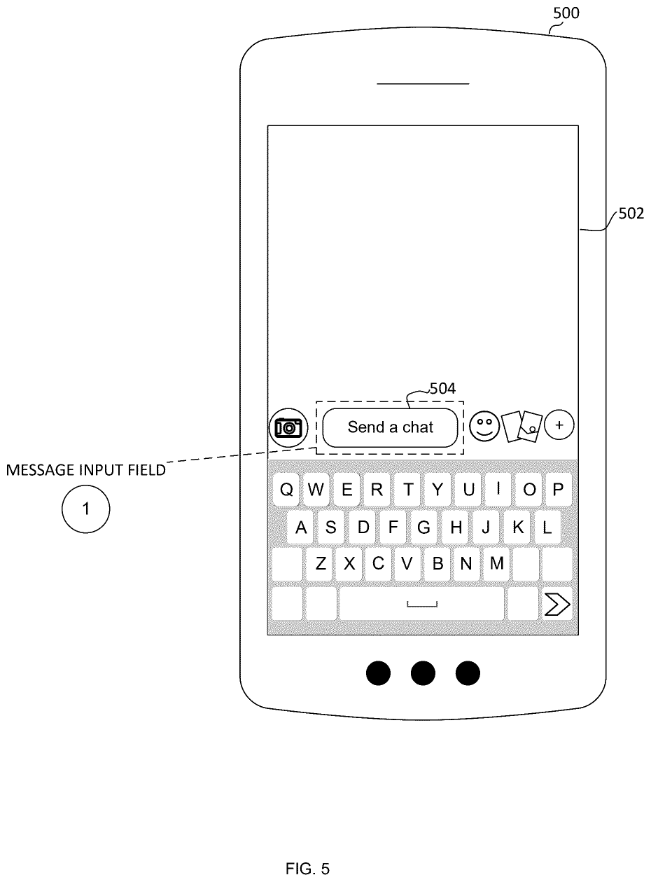

FIG. 5 illustrates a user interface diagram of a mobile device 500, showcasing the user interface 502 for a chat application. This diagram provides a visual representation of the chat application's layout on a mobile device 500, emphasizing the components involved in the user interaction for generating custom stickers. In FIG. 5, the central element of the user interface 502 is the text input box, also referred to as a message input field 504. This component serves as the primary input method for users to communicate within the chat application. The message input field 504 allows users to type and enter their chat messages, which can include text, emojis, or other forms of digital communication. The message input field 504 is typically located at the bottom of the chat interface, making it easily accessible for users to engage in ongoing conversations. As shown in FIG. 5, the process of creating a customer sticker using the chat application begins at step number one, where the user interacts with the message input field 504.

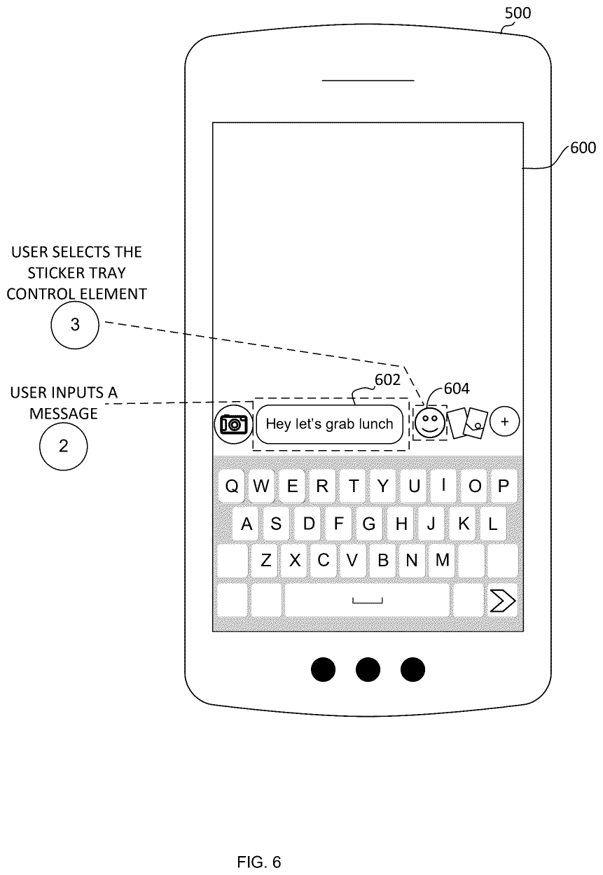

Turning now to FIG. 6 and the depicted user interface 600 on the same mobile device 500, the user can enter any text they wish to communicate in the message input field. This text could be a simple message, a question, a reaction, or any statement that the user intends to send to another party within the chat. The flexibility of the message input field allows for diverse forms of expression, catering to the dynamic nature of personal communication. Once the user has entered their desired message into the message input field 504, they can proceed to send the message to other chat participants by using the send button. Additionally, this text input can trigger other interactive features of the chat application, such as the generation of custom stickers related to the text entered, enhancing the user's ability to express emotions and reactions visually.

As shown in FIG. 6, the user has entered the message “Hey let's grab lunch” 602 into the message input field, which is identified as step two in the overall custom sticker creation process. This message is displayed within the chat interface, indicating that the user has successfully inputted their text and is potentially ready to send it or use it to generate related digital content, such as a custom sticker. Following the entry of the message, the user decides to create a custom sticker derived from the text of the message. To initiate this process, as step three, the user interacts with the sticker tray control element, marked with reference number 604. This element is visually represented in the diagram as being selected by the user, as indicated by the circle encompassing it. The selection of the sticker tray control element 604 signifies the user's intent to access a set of sticker options or to trigger the generation of a new, custom sticker based on the input message.

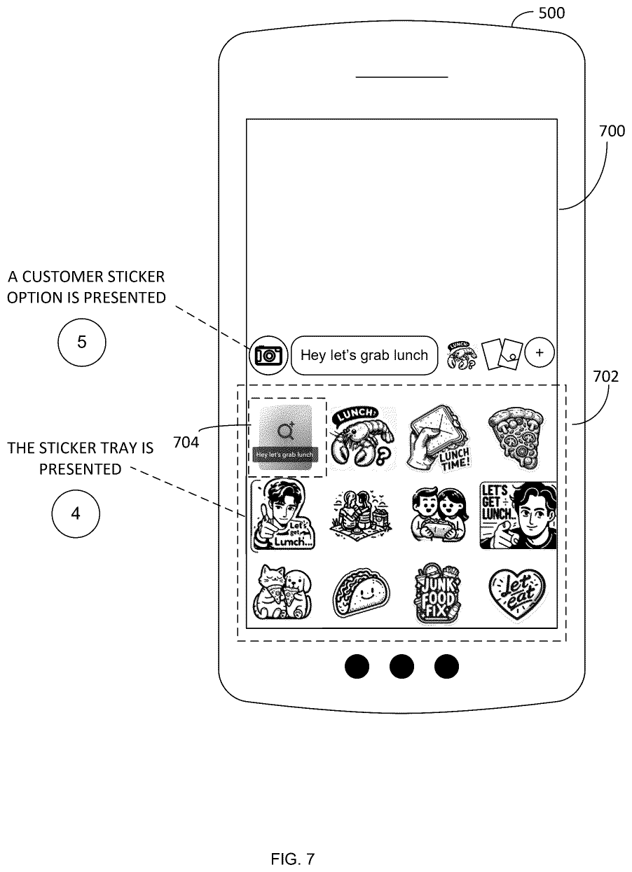

Turning now to FIG. 7, a detailed view of the sticker tray 702 that is presented to the user is presented, showcasing the variety of sticker options available for enhancing their chat conversation. As a result of the user selecting the sticker tray control element 604 (FIG. 6), the user interface 700 shown on the device 500 in FIG. 7 includes the sticker tray 702, presenting the user with a variety of stickers, as step 4. In some examples, the stickers that populate the sticker tray may be selected and presented based on their relevance to the input text (e.g., “Hey let's grab lunch”).

The sticker tray 702 is a component of the user interface that appears after the user selects the sticker tray control element 604. It is designed to offer a wide range of stickers that users can seamlessly integrate into their chat conversations to express emotions, reactions, or to simply add a fun visual element to the dialogue. The sticker tray 702 is typically displayed at the bottom or side of the chat interface, allowing easy access for the user to browse and select stickers.

Within the sticker tray 702, one notable feature is the inclusion of a custom sticker icon, identified with reference number 704 in FIG. 7. This custom sticker icon 704 is distinct because it directly relates to the text the user previously entered into the message input field, “Hey let's grab lunch.” The icon 704 for this custom sticker visually represents this text. As step five, by selecting this custom sticker icon 704 from the sticker tray 702, the user can initiate the creation of a custom sticker that visually encapsulates the message “Hey let's grab lunch.” This process involves the application's backend systems, which may use generative models to interpret the text and produce a custom sticker that creatively represents the message's content. The resulting sticker can then be added to the chat, enhancing the conversation with a visual element that is both relevant and engaging.

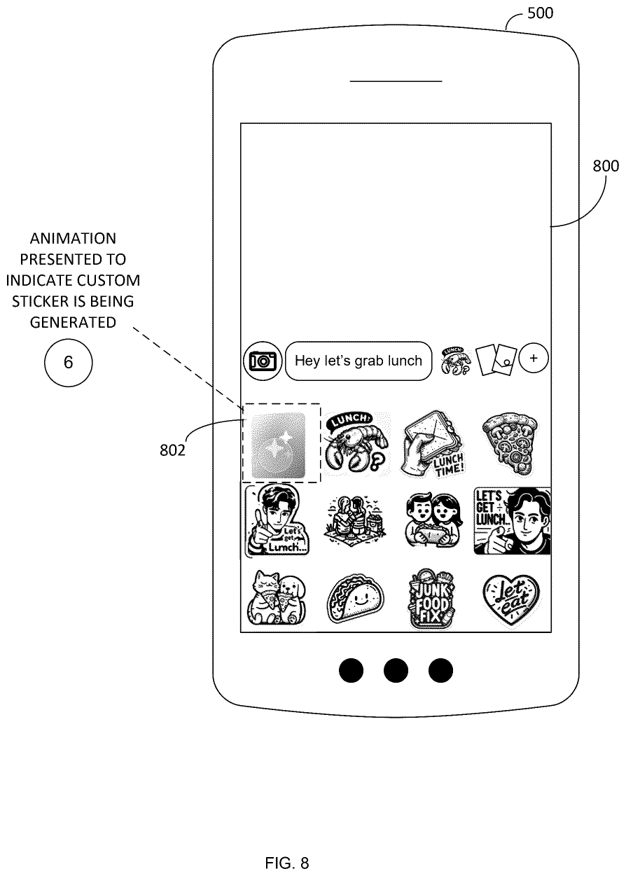

FIG. 8 illustrates the user interface 800 on the computing device 500, capturing the dynamic response of the chat application when a user selects the custom sticker icon 704 as previously described in FIG. 7. FIG. 8 specifically focuses on the visual feedback provided to the user through an animation in the sticker tray, as step six, indicating that the custom sticker is currently being generated. For example, upon the user's selection of the custom sticker icon 704, a request is sent to the server system responsible for generating the custom sticker. This action triggers the backend processes where generative models and other computational mechanisms are employed to create a custom sticker based on the user's input text, “Hey let's grab lunch.” The complexity of generating a custom sticker requires a brief processing period during which the server system synthesizes the textual input into a visual representation. To enhance the user experience and maintain engagement during this processing time, an animation 802 is displayed within the sticker tray. This animation 802 serves a dual purpose: it reassures the user that their request is being processed and provides a visual indicator that helps manage expectations regarding the wait time. The animation might typically manifest as a loading spinner, a progress bar, or a series of playful, contextually appropriate graphics that animate in a loop.

The presence of this animation in the sticker tray helps to prevent user frustration that might arise from a perceived delay. By visually occupying the user with an engaging animation 802, the application effectively communicates that the creation of the custom sticker is underway and will be completed shortly. This thoughtful design consideration ensures that the user remains informed and patient while the requested sticker is being crafted.

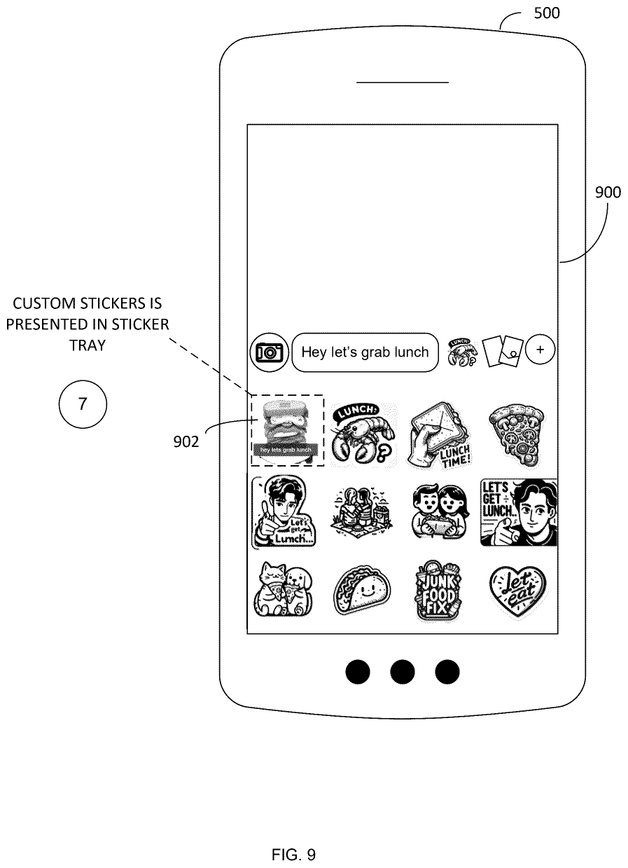

Following the animation indicating the processing of the custom sticker, FIG. 9 presents the user interface 900 on the mobile device 500, where the sticker tray now displays the completed custom sticker 902, as step seven. This sticker 902, prominently featuring a visually appealing depiction of a multi-layered sandwich, effectively captures the essence of the user's input text, “Hey let's grab lunch.” The integration of the text into the sticker design not only enhances the sticker's relevance but also enriches the communicative value of the user's message within the chat.

The custom sticker 902 is designed to be both eye-catching and contextually appropriate, reflecting the casual and inviting nature of the message. By selecting this sticker from the sticker tray, the user can effortlessly add it to their chat conversation, offering a fun and engaging way to express the suggestion to grab lunch through a creative visual format. The sticker tray in user interface 900 is strategically positioned to facilitate easy access and selection, ensuring that users can quickly find and use their newly created custom sticker without disrupting the flow of conversation. This seamless integration of custom stickers into the chat interface underscores the system's capability to enhance user interaction by providing personalized and visually engaging communication options.

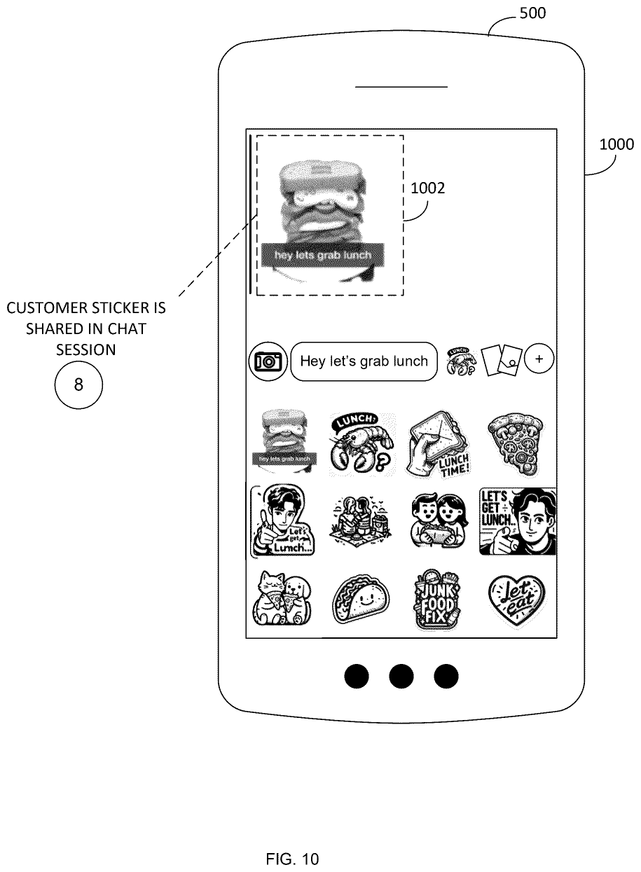

In FIG. 10 the user interface 1000 on the mobile device 500 illustrates the successful transmission of the custom sticker as a chat message to another user, marking step eight in the process. This interface update shows that the custom sticker, featuring the multi-layered sandwich and captioned “Hey let's grab lunch,” has been selected by the user and sent over the network. The chat interface now displays the sticker within the conversation thread, visually confirming its placement as part of the ongoing dialogue.

This action not only demonstrates the sticker's integration into the chat but also highlights the system's efficiency in handling and transmitting custom content seamlessly across users. The interface in FIG. 10 is designed to provide clear visual feedback to the user that their message has been sent, enhancing user confidence and satisfaction with the interaction process. The sent sticker appears in the chat window as it would appear to the receiving party, ensuring that the sender has a precise understanding of how the message will be presented on the other end. This final step in the sticker's journey—from creation to transmission—underscores the system's capability to foster engaging and personalized communication in a digital environment,

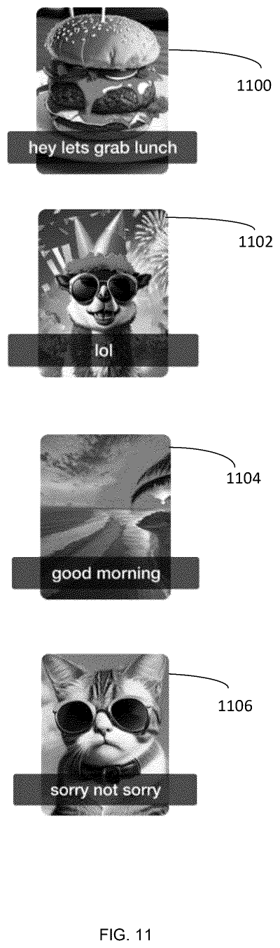

FIG. 11 illustrates a variety of custom stickers each overlaid with captions that reflect the original messages from which these stickers were generated, consistent with various examples. This figure provides a visual representation of how textual inputs are transformed into themed stickers, enhancing the user's ability to communicate through personalized visual content.

Each sticker displayed in FIG. 11 is paired with a caption that directly corresponds to the text input used during the sticker creation process. For instance, sticker number 1100 prominently features the caption “hey let's grab lunch,” which was the user's original message. This text served as the input for the generative model that produced a corresponding image of a hamburger, visually representing the concept of lunch as suggested by the text.

The other stickers in the figure follow a similar pattern, where each caption is a direct quote of the input message, and the image reflects the theme or sentiment of that message. This demonstrates the application's capability to interpret textual inputs and creatively convert them into relevant visual stickers that maintain the context and enhance the communicative intent of the original message.

The inclusion of multiple examples in FIG. 11 serves to illustrate the versatility and adaptability of the sticker generation process. It shows that the system can handle a variety of messages, each resulting in a unique and contextually appropriate sticker. This capability allows users to express a wide range of emotions and ideas through a combination of text and imagery, making digital communication more dynamic and engaging.

Overall, FIG. 11 effectively demonstrates the final output of the custom sticker generation process, highlighting how the chat application leverages advanced generative models to enrich user interactions. By seamlessly integrating text and visuals, the application supports a more expressive and visually stimulating chat environment, encouraging users to explore creative ways of communication.

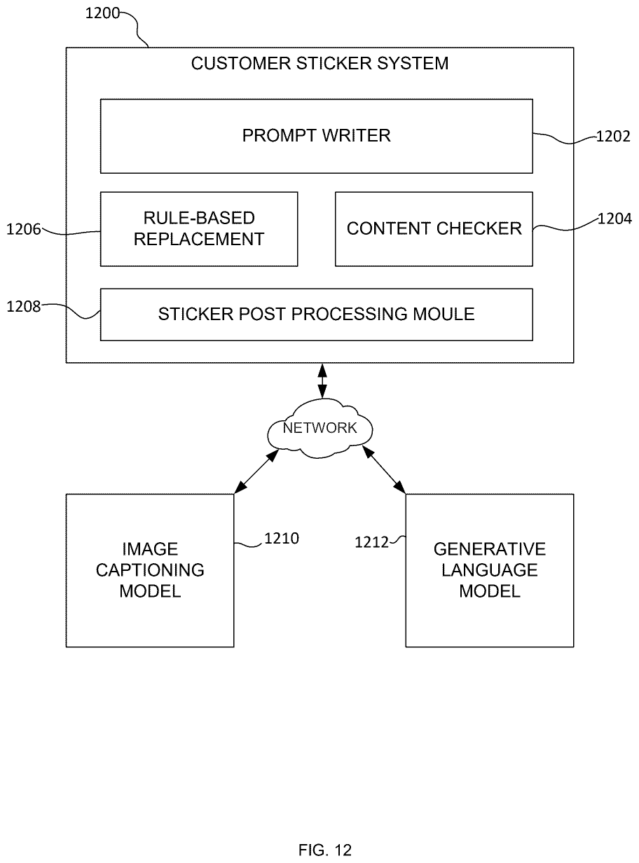

FIG. 12 is a diagram illustrating a detailed view of a custom sticker system 1200 that leverages generative machine learning models for generating custom captions, consistent with some examples. Consistent with this example, as illustrated in FIG. 12, the custom sticker system 1200 introduces an approach to sticker creation by starting with an image or a portion of an image received from a client device. This image serves as the primary input for the image captioning model 1210, a pre-trained model specifically designed to analyze visual content and generate a textual description of the depicted scenes or subjects. The image captioning model 1210 employs advanced machine learning techniques, in some examples leveraging convolutional neural networks or other image recognition technologies, to accurately interpret the visual data and articulate what is portrayed in the image. This capability allows the system to understand and describe complex visual inputs, transforming them into descriptive text that captures the essence of the image.

The image captioning model 1210 within the custom sticker system 1200 is a component that transforms visual data into descriptive text. This model is built on advanced machine learning frameworks, in some examples employing convolutional neural networks (CNNs) or similar image recognition technologies that are adept at analyzing and interpreting visual content. The model's primary function is to scan the image received from the client device, identify key elements and scenes, and generate a coherent textual description that accurately reflects the content of the image.

Training the image captioning model 1210 involves a comprehensive dataset consisting of numerous images (e.g., stickers) paired with corresponding captions that describe each image in detail. This dataset is used in a supervised learning setup where the model learns to associate specific visual patterns and objects with textual descriptors. During the training phase, the model is exposed to a wide variety of images encompassing different objects, scenes, and contexts to ensure a broad understanding of possible visual inputs. Techniques such as transfer learning are often employed, where a model pre-trained on a vast image dataset is fine-tuned with specific captioning data, enhancing its ability to generate relevant and accurate descriptions.

The operational mechanism of the image captioning model involves several steps. Initially, when an image is input into the system, the model utilizes its trained CNNs to extract features and identify significant components of the image. Following feature extraction, another segment of the model, often a recurrent neural network (RNN) or a transformer-based architecture, takes over to process the sequential data of the features to construct a sentence that logically describes the image. This process involves selecting appropriate words and structuring them into a coherent sentence, often optimizing for grammatical correctness and relevance to the visual content.

The output from the image captioning model 1210 is a clear, concise caption that encapsulates the essence of the image. This caption can then be used within the custom sticker system to create stickers that are not only visually appealing but also contextually enriched with descriptive text, enhancing the communicative value of the stickers in digital interactions. This integration of advanced image captioning capabilities significantly augments the functionality of the custom sticker system, enabling it to deliver highly personalized and engaging content to users.

Once the image captioning model 1210 produces a textual description, this output is subjected to a review by the content checker 1204. Similar to its function in the previously described system (FIG. 3), the content checker 1204 evaluates the generated text to ensure it adheres to predefined content guidelines and policies. This step is important for maintaining the appropriateness of the content, as it filters out any undesirable or sensitive elements that might have been inadvertently included in the textual description. Following this, the rule-based replacement module 1206 further refines the text by applying specific rules designed to replace or adjust certain words or phrases. This module enhances the suitability and quality of the text, ensuring that it aligns with the platform's standards and user expectations.

Subsequently, the refined text description is passed to the prompt writer 1202, which is responsible for crafting a prompt based on the output from the image captioning model. The prompt writer 1202 uses a template or a set of guidelines to formulate a prompt that effectively instructs the generative language model 1212 on how to proceed with caption generation. This prompt includes the necessary context and directives to guide the generative language model 1212 in creating one or more captions that are not only relevant to the image but also engaging and creative.

The generative language model 1212, accessed possibly over a network, then processes the prompt to generate captions. This generative language model may be based on a transformer-based LLM, interprets the prompt, as input, and produces captions, as output, that complement the original image. Depending on the implementation, the generative language model may offer multiple caption alternatives, providing a range of choices that vary in tone, style, or perspective.

The outputs from the generative language model are then received by the sticker post-processing module 1208, which compiles the final sticker images. This module 1208 integrates the original image with one or more of the generated captions, formatting and positioning the text to enhance visual appeal and readability. In some embodiments, multiple custom stickers might be created, each featuring a different caption, thereby giving users a variety of stickers to choose from.

Finally, these custom stickers with captions are sent back to the user system or client device, where they can be used in interactive chats with other end-users. This integration allows users to enrich their communication with visually expressive and contextually relevant stickers, enhancing the overall chat experience and fostering more engaging conversations. The seamless flow from image receipt to sticker output underscores the system's efficiency and user-centric design, making it a valuable feature for any digital communication platform.

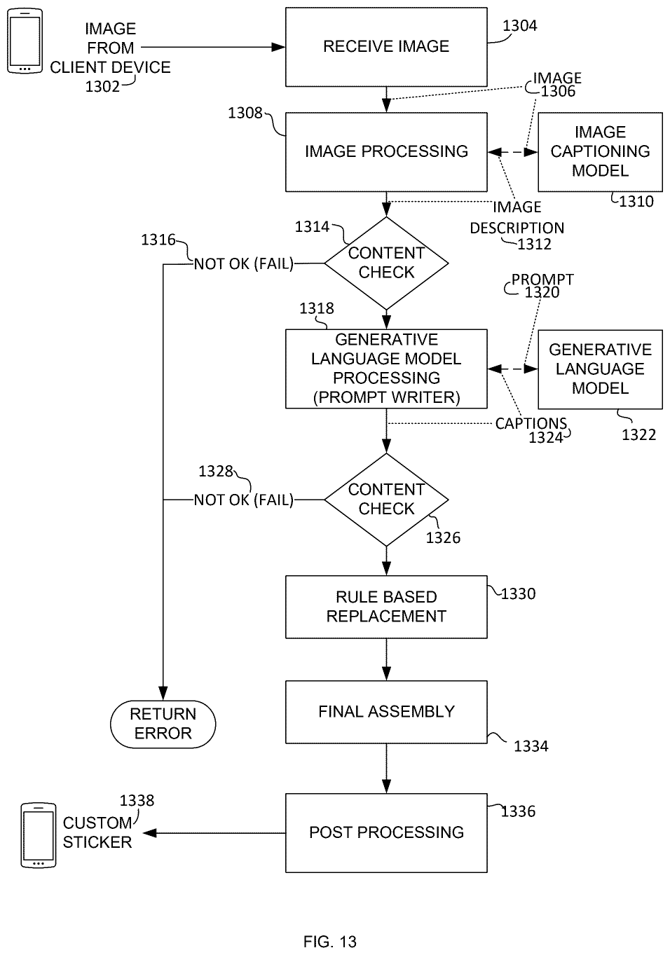

FIG. 13 illustrates a detailed method employed by the custom sticker system 1200 to generate custom stickers with captions, leveraging the capabilities of generative machine learning models. This method begins at operation 1304 with the reception of an image from a client device 1302, which serves as the primary input for the subsequent processes. The initial input image received by the custom sticker system can be a full photograph or image stored in the camera roll or captured directly using the camera on the mobile device. In some instances, the image may be a partial image, such as only the subject portion, for example, with the background removed. This background removal is often facilitated by a process performed at the client device, utilizing operating system or system-provided functions that are accessible via an API. This capability allows for greater focus on the main subject of the image, enhancing the relevance and impact of the generated custom sticker and custom caption.

At operation 1308, the image 1306 is processed by providing the image as an input to an image captioning model 1310. This image captioning model 1310 will process the image to generate, as output, a detailed image description 1312 describing what is depicted by the image or photo. The description aims to encapsulate the key elements and overall essence of the image, transforming visual data into a descriptive text format.

Following the generation of the image description 1312, a content check 1314 is performed to ensure that the image description 1312 adheres to predefined standards and guidelines. This step is important for filtering out any inappropriate content and ensuring that the descriptions are suitable for general audiences. If the content check fails, 1316, an error message may be generated and returned to the client device.

Having generated a suitable image description, the process advances to the generative language model processing 1318. The prompt writer uses the image description created by the image captioning model at 1310 to generate a prompt 1320, which instructs the generative language model 1322 to generate one, or some predetermined number, of captions, based on the image description 1312. The prompt 1320 may include additional instructions to influence the style or theme of the caption. This model takes the prompt, including the image description as input, and generates potential captions 1324 that are contextually aligned with the described image. The generative language model 1322 may generate multiple caption options, offering a variety of choices that can creatively complement the image.

Before finalizing the captions, a content check 1326 is conducted to ensure that the revised captions meet all necessary content standards, and a rule-based replacement 1330 is applied to refine the captions by replacing or adjusting specific words or phrases to enhance clarity or appropriateness.

Then, during final assembly 1334, the caption or in some instances, multiple captions, are paired with the original image to create one or more custom stickers. During this phase, additional graphical adjustments might be made, such as cropping the image or adding graphical elements to enhance the visual appeal of the sticker.

Finally, during the post processing 1336, the fully assembled custom sticker(s), now complete with a visually appealing image and a contextually relevant caption, is sent back to the client device. The custom sticker or stickers 1338 can then be used within the chat application or shared across various platforms, enhancing communication with a personalized and expressive visual element.

This method, as depicted in FIG. 13, showcases a comprehensive approach to generating custom stickers that are not only visually engaging but also enriched with meaningful captions. By integrating advanced image processing and language generation models, the system ensures that each sticker is both aesthetically pleasing and contextually relevant, thereby enhancing the user's digital communication experience.

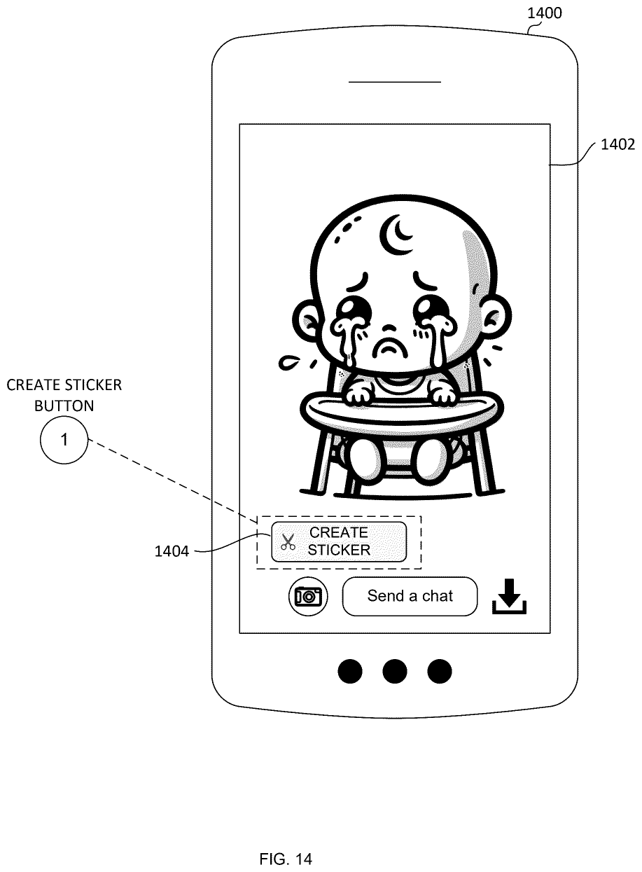

In FIG. 14, the user interface 1400 on the mobile device displays the initial step (step one) in creating a custom sticker with a caption from an original image. The interface 1402 features a prominent “Create Sticker” button 1404, which the user can tap to initiate the sticker creation process. This button 1404 is intuitively placed within the user's view, making it easily accessible and straightforward to use. In some examples, upon tapping this button, the system will extract the foreground image from the background, for example, by calling a function or API of the operating system.

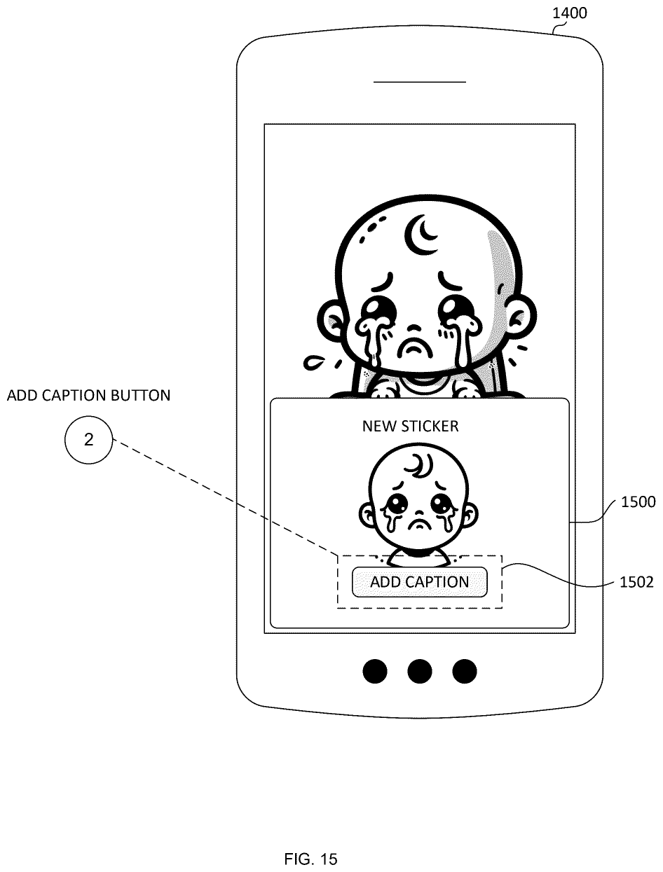

Moving to FIG. 15, once the “Create Sticker” button has been activated, the user interface 1500 transitions to display an “Add Caption” button 1502. This button is designed to prompt the user to generate a custom caption for the newly created sticker. In some examples, the user can tap on this button, which leads to a caption input field where the user can either type in a custom caption or choose to generate one automatically using the system's AI capabilities. This allows the user to personalize the sticker further, making it more relevant and engaging.

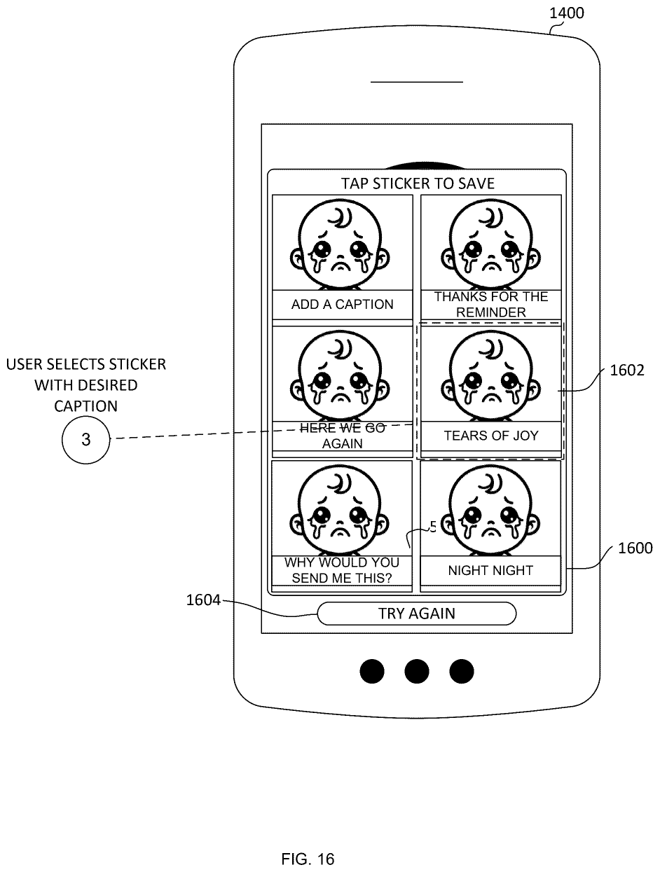

In FIG. 16, the user interface 1600 illustrates the selection process for the custom sticker with the newly added caption. Here, the user is presented with multiple caption options generated by the AI based on the context of the original image or user input. The interface 1600 displays these options in a simple, scrollable format, allowing the user to review and select the most suitable caption. Each caption option is displayed alongside a preview of what the final sticker will look like, providing a clear and immediate visual reference for the user. In some examples, by tapping or selecting a sticker at this stage, the sticker may be saved to a set of stickers (e.g., favorites), or the sticker may be communicated to another user, depending upon the entry point via which the user entered the customer sticker and custom caption flow. As shown with reference number 1604, in some examples a button (“Try Again”) may be presented, and when selected, the caption process may be repeated to generate a new set of captions.

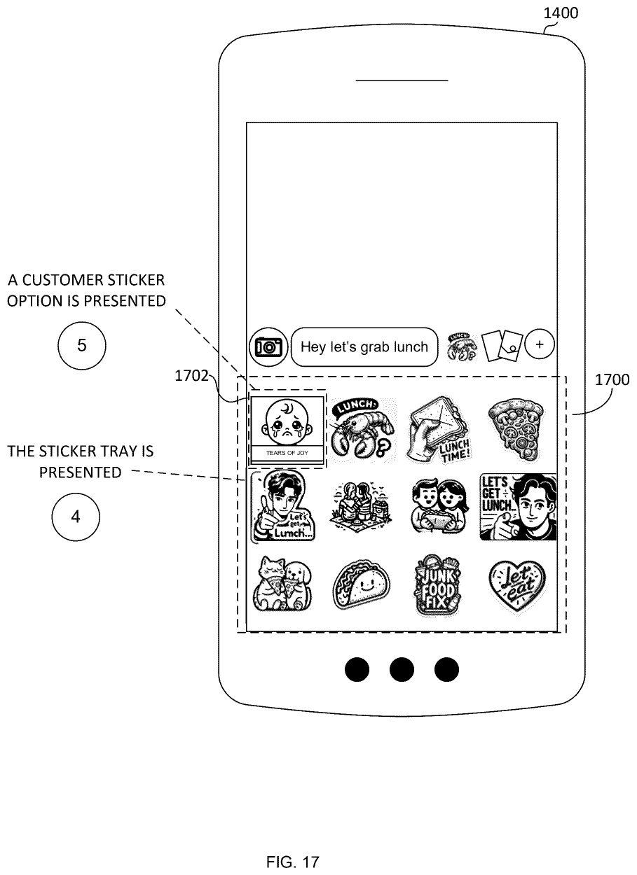

Finally, FIG. 17 shows a user interface 1700 where the complete custom sticker, now combined with the chosen caption, is presented in the sticker tray 1702. This tray showcases the final sticker, fully rendered with the original image and the custom caption integrated. The user can then simply tap on the sticker to add it to their message or save it to their sticker collection for future use. The sticker tray is designed to be user-friendly, offering a seamless experience from sticker creation to application in communication.

Throughout these figures, the user interface is crafted to facilitate an intuitive and efficient interaction flow for creating custom stickers with captions. However, those skilled in the art will appreciate that many variations of the flow exemplified by the several figures are possible. By leveraging AI-driven tools and a well-designed UI, the system ensures that users can easily personalize their communication in a fun and creative way.

### Machine Architecture

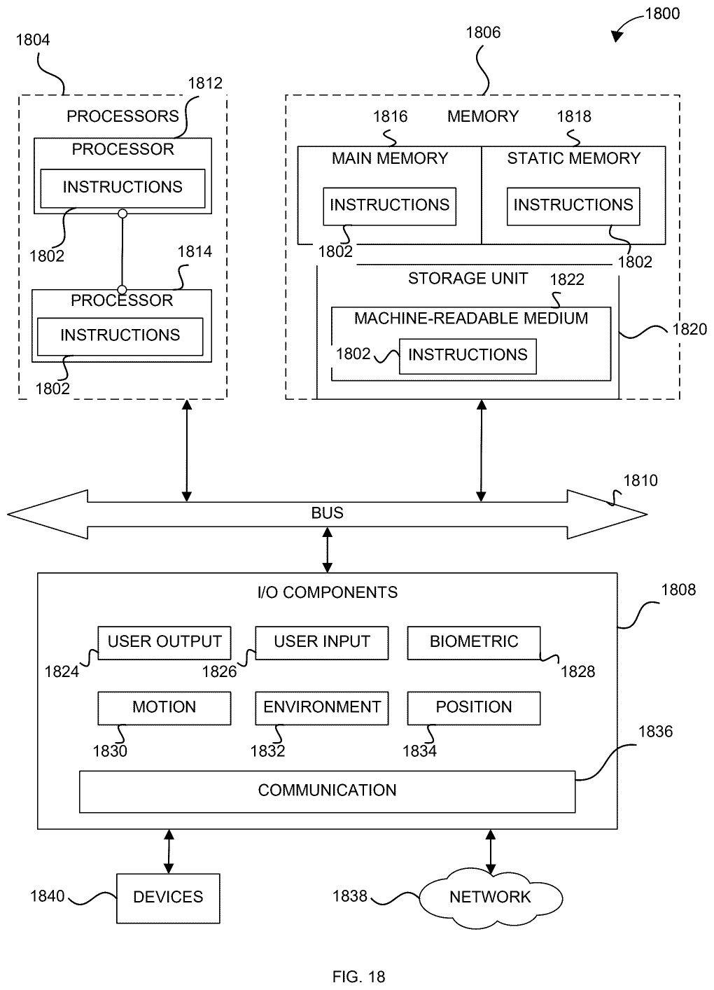

FIG. 18 is a diagrammatic representation of the machine 1800 within which instructions 1802 (e.g., software, a program, an application, an applet, an app, or other executable code) for causing the machine 1800 to perform any one or more of the methodologies discussed herein may be executed. For example, the instructions 1802 may cause the machine 1800 to execute any one or more of the methods described herein. The instructions 1802 transform the general, non-programmed machine 1800 into a particular machine 1800 programmed to carry out the described and illustrated functions in the manner described. The machine 1800 may operate as a standalone device or may be coupled (e.g., networked) to other machines. In a networked deployment, the machine 1800 may operate in the capacity of a server machine or a client machine in a server-client network environment, or as a peer machine in a peer-to-peer (or distributed) network environment. The machine 1800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smartwatch or smart glasses), a wearable augmented/virtual/mixed reality device, a smart home device (e.g., a smart appliance), other smart devices, a web appliance, a network router, a network switch, a network bridge, or any machine capable of executing the instructions 1802, sequentially or otherwise, that specify actions to be taken by the machine 1800. Further, while a single machine 1800 is illustrated, the term “machine” shall also be taken to include a collection of machines that individually or jointly execute the instructions 1802 to perform any one or more of the methodologies discussed herein. The machine 1800, for example, may comprise a user system or any one of multiple server devices forming part of an interaction server system for posting and sharing messages and other content. In some examples, the machine 1800 may also comprise both client and server systems, with certain operations of a particular method or algorithm being performed on the server-side and with certain operations of the particular method or algorithm being performed on the client-side.

The machine 1800 may include processors 1804, memory 1806, and input/output I/O components 1808, which may be configured to communicate with each other via a bus 1810. In an example, the processors 1804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1812 and a processor 1814 that execute the instructions 1802. The term “processor” is intended to include multi-core processors that may comprise two or more independent processors (sometimes referred to as “cores”) that may execute instructions contemporaneously. Although FIG. 18 shows multiple processors 1804, the machine 1800 may include a single processor with a single-core, a single processor with multiple cores (e.g., a multi-core processor), multiple processors with a single core, multiple processors with multiples cores, or any combination thereof.

The memory 1806 includes a main memory 1816, a static memory 1818, and a storage unit 1820, both accessible to the processors 1804 via the bus 1810. The main memory 1806, the static memory 1818, and storage unit 1820 store the instructions 1802 embodying any one or more of the methodologies or functions described herein. The instructions 1802 may also reside, completely or partially, within the main memory 1816, within the static memory 1818, within machine-readable medium 1822 within the storage unit 1820, within at least one of the processors 1804 (e.g., within the processor's cache memory), or any suitable combination thereof, during execution thereof by the machine 1800.

The I/O components 1808 may include a wide variety of components to receive input, provide output, produce output, transmit information, exchange information, capture measurements, and so on. The specific I/O components 1808 that are included in a particular machine will depend on the type of machine. For example, portable machines such as mobile phones may include a touch input device or other such input mechanisms, while a headless server machine will likely not include such a touch input device. It will be appreciated that the I/O components 1808 may include many other components that are not shown in FIG. 18. In various examples, the I/O components 1808 may include user output components 1824 and user input components 1826. The user output components 1824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1808 may include biometric components 1828, motion components 1830, environmental components 1832, or position components 1834, among a wide array of other components. For example, the biometric components 1828 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1830 include acceleration sensor components (e.g., accelerometer), gravitation sensor components, rotation sensor components (e.g., gyroscope).

The environmental components 1832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, a user system may have a camera system comprising, for example, front cameras on a front surface of the user system and rear cameras on a rear surface of the user system. The front cameras may, for example, be used to capture still images and video of a user of the user system (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system may also include a 360° camera for capturing 360° photographs and videos.

Further, the camera system of the user system may include dual rear cameras (e.g., a primary camera as well as a depth-sensing camera), or even triple, quad or penta rear camera configurations on the front and rear sides of the user system. These multiple cameras systems may include a wide camera, an ultra-wide camera, a telephoto camera, a macro camera, and a depth sensor, for example.

The position components 1834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1808 further include communication components 1836 operable to couple the machine 1800 to a network 1838 or devices 1840 via respective coupling or connections. For example, the communication components 1836 may include a network interface component or another suitable device to interface with the network 1838. In further examples, the communication components 1836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1840 may be another machine or any of a wide variety of peripheral devices (e.g., a peripheral device coupled via a USB).

Moreover, the communication components 1836 may detect identifiers or include components operable to detect identifiers. For example, the communication components 1836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1836, such as location via Internet Protocol (IP) geolocation, location via Wi-Fi® signal triangulation, location via detecting an NFC beacon signal that may indicate a particular location, and so forth.

The various memories (e.g., main memory 1816, static memory 1818, and memory of the processors 1804) and storage unit 1820 may store one or more sets of instructions and data structures (e.g., software) embodying or used by any one or more of the methodologies or functions described herein. These instructions (e.g., the instructions 1802), when executed by processors 1804, cause various operations to implement the disclosed examples.

The instructions 1802 may be transmitted or received over the network 1838, using a transmission medium, via a network interface device (e.g., a network interface component included in the communication components 1836) and using any one of several well-known transfer protocols (e.g., hypertext transfer protocol (HTTP)). Similarly, the instructions 1802 may be transmitted or received using a transmission medium via a coupling (e.g., a peer-to-peer coupling) to the devices 1840.

### Software Architecture

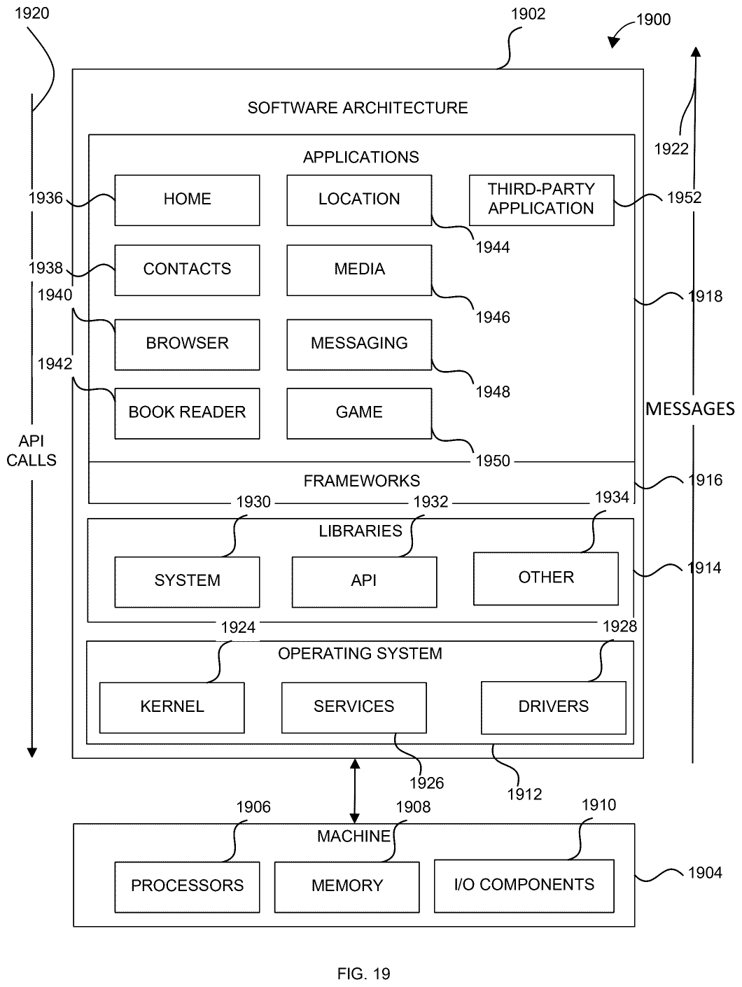

FIG. 19 is a block diagram 1900 illustrating a software architecture 1902, which can be installed on any one or more of the devices described herein. The software architecture 1902 is supported by hardware such as a machine 1904 that includes processors 1906, memory 1908, and I/O components 1910. In this example, the software architecture 1902 can be conceptualized as a stack of layers, where each layer provides a particular functionality. The software architecture 1902 includes layers such as an operating system 1912, libraries 1914, frameworks 1916, and applications 1918. Operationally, the applications 1918 invoke API calls 1920 through the software stack and receive messages 1922 in response to the API calls 1920.

The operating system 1912 manages hardware resources and provides common services. The operating system 1912 includes, for example, a kernel 1924, services 1926, and drivers 1928. The kernel 1924 acts as an abstraction layer between the hardware and the other software layers. For example, the kernel 1924 provides memory management, processor management (e.g., scheduling), component management, networking, and security settings, among other functionalities. The services 1926 can provide other common services for the other software layers. The drivers 1928 are responsible for controlling or interfacing with the underlying hardware. For instance, the drivers 1928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1914 provide a common low-level infrastructure used by the applications 1918. The libraries 1914 can include system libraries 1930 (e.g., C standard library) that provide functions such as memory allocation functions, string manipulation functions, mathematic functions, and the like. In addition, the libraries 1914 can include API libraries 1932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1914 can also include a wide variety of other libraries 1934 to provide many other APIs to the applications 1918.

The frameworks 1916 provide a common high-level infrastructure that is used by the applications 1918. For example, the frameworks 1916 provide various graphical user interface (GUI) functions, high-level resource management, and high-level location services. The frameworks 1916 can provide a broad spectrum of other APIs that can be used by the applications 1918, some of which may be specific to a particular operating system or platform.

In an example, the applications 1918 may include a home application 1936, a contacts application 1938, a browser application 1940, a book reader application 1942, a location application 1944, a media application 1946, a messaging application 1948, a game application 1950, and a broad assortment of other applications such as a third-party application 1952. The applications 1918 are programs that execute functions defined in the programs. Various programming languages can be employed to create one or more of the applications 1918, structured in a variety of manners, such as object-oriented programming languages (e.g., Objective-C, Java, or C++) or procedural programming languages (e.g., C or assembly language). In a specific example, the third-party application 1952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1952 can invoke the API calls 1920 provided by the operating system 1912 to facilitate functionalities described herein.

### EXAMPLES

Example 1 is a method performed by a server for generating a custom sticker in response to a request from a client device, the method comprising: receiving the request from the client device, the request including text input into a message input field of a chat interface presented at the client device; and processing the request by: dynamically generating a first prompt based on the text received with the request using a first predefined prompt template, the first prompt including an instruction to a generative language model to interpret the text and generate, as output, a textual description of the custom sticker; providing the first prompt to a generative language model, as input, and receiving from the generative language model, as output, the textual description of the custom sticker; dynamically generating a second prompt to include, the textual description of the custom sticker using a second predefined prompt template, the second prompt including an instruction to a generative image model to interpret the textual description of the custom sticker and generate, as output, an image file representing the custom sticker; providing the second prompt to the generative image model, as input, and receiving from the generative image model, as output, an image file representing the custom sticker; and sending the image file representing the custom sticker to the client device.

In Example 2, the subject matter of Example 1 includes, prior to sending the image file to the client device, processing the image file by overlaying a caption onto an image of the image file, the caption derived to include the text input into the message input field of the chat interface.

In Example 3, the subject matter of Examples 1-2 includes, prior to dynamically generating the first prompt, performing a content check on the text received with the request by comparing the text against a predefined list of objectionable words and phrases; and discontinuing the processing of the request if the content check identifies any words or phrases, within the text, from the predefined list of objectionable words and phrases.

In Example 4, the subject matter of Examples 1-3 includes, wherein dynamically generating the first prompt further comprises: dynamically generating the first prompt using the first predefined prompt template to include instructions to the generative language model to format the output as a JavaScript Object Notation (JSON) object, the JSON object to include i) the textual description of the custom sticker, and ii) the text received with the request as input via the message input field of the chat interface.

In Example 5, the subject matter of Examples 1˜4 includes, prior to dynamically generating the second prompt, performing a content check on the textual description of the custom sticker received as output from the generative language model; and upon the content check passing, performing a rule-based term replacement process on the textual description of the custom sticker to replace specific words or phrases with alternative words or phrases, according to one or more predefined rules.

In Example 6, the subject matter of Examples 1-5 includes, wherein dynamically generating the second prompt comprises: dynamically generating the second prompt using the second predefined prompt template to include an input prompt specifying the textual description of the custom sticker, and a negative prompt specifying, as constraints, undesirable elements and characteristics to be excluded from the image file representing the custom sticker.

In Example 7, the subject matter of Example 6 includes, wherein dynamically generating the second prompt further comprises: dynamically generating the second prompt using the second predefined prompt template to include one or more examples, each example comprising a textual description of a sticker paired with an image file representing a sticker, as desired output.

In Example 8, the subject matter of Examples 1-7 includes, wherein the generative language model is a Large Language Model (LLM) accessible to the server over a network.

In Example 9, the subject matter of Examples 1-8 includes, wherein the generative image model is selected from the group consisting of: a Generative Adversarial Network (GAN), utilizing competing neural networks to generate image files with images that are visually similar to authentic images based on text-based prompts; a Variational Autoencoder (VAE), using a probabilistic approach to generate image files with images by encoding inputs into a latent space and then decoding them back to outputs, guided by text-based prompts; and a Transformer-based model, designed for image generation by processing text-based prompts through self-attention mechanisms to produce image files with images.

In Example 10, the subject matter of Examples 1-9 includes, wherein sending the custom sticker to the client device includes causing the client device to: present the custom sticker along with a plurality of other stickers within a sticker tray of the chat interface, each sticker within the sticker tray user-selectable and, upon selection of a sticker in the sticker tray, the selected sticker will populate the message input field of the client device, thereby enable a user to send the selected sticker to another user over a network by activating a send button in the chat interface.

Example 11 is a system for generating a custom sticker in response to a request from a client device, the system comprising: at least one processor; at least one memory storage device storing instructions thereon, which, when executed by the at least one processor, cause the system to perform operations comprising: receiving the request from the client device, the request including text input into a message input field of a chat interface presented at the client device; and processing the request by: dynamically generating a first prompt based on the text received with the request using a first predefined prompt template, the first prompt including an instruction to a generative language model to interpret the text and generate, as output, a textual description of the custom sticker; providing the first prompt to a generative language model, as input, and receiving from the generative language model, as output, the textual description of the custom sticker; dynamically generating a second prompt to include, the textual description of the custom sticker using a second predefined prompt template, the second prompt including an instruction to a generative image model to interpret the textual description of the custom sticker and generate, as output, an image file representing the custom sticker; providing the second prompt to the generative image model, as input, and receiving from the generative image model, as output, an image file representing the custom sticker; and sending the image file representing the custom sticker to the client device.

In Example 12, the subject matter of Example 11 includes, wherein the operations further comprise: prior to sending the image file to the client device, processing the image file by overlaying a caption onto an image of the image file, the caption derived to include the text input into the message input field of the chat interface.

In Example 13, the subject matter of Examples 11-12 includes, wherein the operations further comprise: prior to dynamically generating the first prompt, performing a content check on the text received with the request by comparing the text against a predefined list of objectionable words and phrases; and discontinuing the processing of the request if the content check identifies any words or phrases, within the text, from the predefined list of objectionable words and phrases.

In Example 14, the subject matter of Examples 1-13 includes, wherein dynamically generating the first prompt further comprises: dynamically generating the first prompt using the first predefined prompt template to include instructions to the generative language model to format the output as a JavaScript Object Notation (JSON) object, the JSON object to include i) the textual description of the custom sticker, and ii) the text received with the request as input via the message input field of the chat interface.

In Example 15, the subject matter of Examples 11-14 includes, wherein the operations further comprise: prior to dynamically generating the second prompt, performing a content check on the textual description of the custom sticker received as output from the generative language model; and upon the content check passing, performing a rule-based term replacement process on the textual description of the custom sticker to replace specific words or phrases with alternative words or phrases, according to one or more predefined rules.

In Example 16, the subject matter of Examples 11-15 includes, wherein dynamically generating the second prompt comprises: dynamically generating the second prompt using the second predefined prompt template to include an input prompt specifying the textual description of the custom sticker, and a negative prompt specifying, as constraints, undesirable elements and characteristics to be excluded from the image file representing the custom sticker.

In Example 17, the subject matter of Example 16 includes, wherein dynamically generating the second prompt further comprises: dynamically generating the second prompt using the second predefined prompt template to include one or more examples, each example comprising a textual description of a sticker paired with an image file representing a sticker, as desired output.

In Example 18, the subject matter of Examples 11-17 includes, wherein the generative language model is a Large Language Model (LLM) accessible to the server over a network.

In Example 19, the subject matter of Examples 11-18 includes, wherein the generative image model is selected from the group consisting of: a Generative Adversarial Network (GAN), utilizing competing neural networks to generate image files with images that are visually similar to authentic images based on text-based prompts; a Variational Autoencoder (VAE), using a probabilistic approach to generate image files with images by encoding inputs into a latent space and then decoding them back to outputs, guided by text-based prompts; and a Transformer-based model, designed for image generation by processing text-based prompts through self-attention mechanisms to produce image files with images.

Example 20 is a system for generating a custom sticker in response to a request from a client device, the system comprising: means for receiving the request from the client device, the request including text input into a message input field of a chat interface presented at the client device; and means for processing the request by: dynamically generating a first prompt based on the text received with the request using a first predefined prompt template, the first prompt including an instruction to a generative language model to interpret the text and generate, as output, a textual description of the custom sticker; providing the first prompt to a generative language model, as input, and receiving from the generative language model, as output, the textual description of the custom sticker; dynamically generating a second prompt to include, the textual description of the custom sticker using a second predefined prompt template, the second prompt including an instruction to a generative image model to interpret the textual description of the custom sticker and generate, as output, an image file representing the custom sticker; providing the second prompt to the generative image model, as input, and receiving from the generative image model, as output, an image file representing the custom sticker; and sending the image file representing the custom sticker to the client device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components, also referred to as “computer-implemented.” Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A method performed by a server for generating a custom sticker in response to a request from a client device, the method comprising:
receiving the request from the client device, the request including text input into a message input field of a chat interface presented at the client device; and
processing the request by:
dynamically generating a first prompt based on the text received with the request using a first predefined prompt template, the first prompt including an instruction to a generative language model to interpret the text and generate, as output, a textual description of the custom sticker;
providing the first prompt to a generative language model, as input, and receiving from the generative language model, as output, the textual description of the custom sticker;
dynamically generating a second prompt to include the textual description of the custom sticker using a second predefined prompt template, the second prompt including an instruction to a generative image model to interpret the textual description of the custom sticker and generate, as output, an image file representing the custom sticker;
providing the second prompt to the generative image model, as input, and receiving from the generative image model, as output, an image file representing the custom sticker; and
sending the image file representing the custom sticker to the client device.

2. The method of claim 1, further comprising:
prior to sending the image file to the client device, processing the image file by overlaying a caption onto an image of the image file, the caption derived to include the text input into the message input field of the chat interface.

3. The method of claim 1, further comprising:
prior to dynamically generating the first prompt, performing a content check on the text received with the request by comparing the text against a predefined list of objectionable words and phrases; and
discontinuing the processing of the request if the content check identifies any words or phrases, within the text, from the predefined list of objectionable words and phrases.

4. The method of claim 1, wherein dynamically generating the first prompt further comprises:
dynamically generating the first prompt using the first predefined prompt template to include instructions to the generative language model to format the output as a JavaScript Object Notation (JSON) object, the JSON object to include i) the textual description of the custom sticker, and ii) the text received with the request as input via the message input field of the chat interface.

5. The method of claim 1, further comprising:
prior to dynamically generating the second prompt, performing a content check on the textual description of the custom sticker received as output from the generative language model; and
upon the content check passing, performing a rule-based term replacement process on the textual description of the custom sticker to replace specific words or phrases with alternative words or phrases, according to one or more predefined rules.

6. The method of claim 1, wherein dynamically generating the second prompt comprises:
dynamically generating the second prompt using the second predefined prompt template to include an input prompt specifying the textual description of the custom sticker, and a negative prompt specifying, as constraints, undesirable elements and characteristics to be excluded from the image file representing the custom sticker.

7. The method of claim 6, wherein dynamically generating the second prompt further comprises:
dynamically generating the second prompt using the second predefined prompt template to include one or more examples, each example comprising a textual description of a sticker paired with an image file representing a sticker, as desired output.

8. The method of claim 1, wherein the generative language model is a Large Language Model (LLM) accessible to the server over a network.

9. The method of claim 1, wherein the generative image model is selected from the group consisting of:
a Generative Adversarial Network (GAN), utilizing competing neural networks to generate image files with images that are visually similar to authentic images based on text-based prompts;
a Variational Autoencoder (VAE), using a probabilistic approach to generate image files with images by encoding inputs into a latent space and then decoding them back to outputs, guided by text-based prompts; and
a Transformer-based model, designed for image generation by processing text-based prompts through self-attention mechanisms to produce image files with images.

10. The method of claim 1, wherein sending the custom sticker to the client device includes causing the client device to:
present the custom sticker along with a plurality of other stickers within a sticker tray of the chat interface, each sticker within the sticker tray user-selectable and, upon selection of a sticker in the sticker tray, the selected sticker will populate the message input field of the client device, thereby enable a user to send the selected sticker to another user over a network by activating a send button in the chat interface.

11. A system for generating a custom sticker in response to a request from a client device, the system comprising:
at least one processor;
at least one memory storage device storing instructions thereon, which, when executed by the at least one processor, cause the system to perform operations comprising:
receiving the request from the client device, the request including text input into a message input field of a chat interface presented at the client device; and
processing the request by:
dynamically generating a first prompt based on the text received with the request using a first predefined prompt template, the first prompt including an instruction to a generative language model to interpret the text and generate, as output, a textual description of the custom sticker;
providing the first prompt to a generative language model, as input, and receiving from the generative language model, as output, the textual description of the custom sticker;
dynamically generating a second prompt to include the textual description of the custom sticker using a second predefined prompt template, the second prompt including an instruction to a generative image model to interpret the textual description of the custom sticker and generate, as output, an image file representing the custom sticker;
providing the second prompt to the generative image model, as input, and receiving from the generative image model, as output, an image file representing the custom sticker; and
sending the image file representing the custom sticker to the client device.

12. The system of claim 11, wherein the operations further comprise:
prior to sending the image file to the client device, processing the image file by overlaying a caption onto an image of the image file, the caption derived to include the text input into the message input field of the chat interface.

13. The system of claim 11, wherein the operations further comprise:
prior to dynamically generating the first prompt, performing a content check on the text received with the request by comparing the text against a predefined list of objectionable words and phrases; and
discontinuing the processing of the request if the content check identifies any words or phrases, within the text, from the predefined list of objectionable words and phrases.

14. The system of claim 1, wherein dynamically generating the first prompt further comprises:
dynamically generating the first prompt using the first predefined prompt template to include instructions to the generative language model to format the output as a JavaScript Object Notation (JSON) object, the JSON object to include i) the textual description of the custom sticker, and ii) the text received with the request as input via the message input field of the chat interface.

15. The system of claim 11, wherein the operations further comprise:
prior to dynamically generating the second prompt, performing a content check on the textual description of the custom sticker received as output from the generative language model; and
upon the content check passing, performing a rule-based term replacement process on the textual description of the custom sticker to replace specific words or phrases with alternative words or phrases, according to one or more predefined rules.

16. The system of claim 11, wherein dynamically generating the second prompt comprises:
dynamically generating the second prompt using the second predefined prompt template to include an input prompt specifying the textual description of the custom sticker, and a negative prompt specifying, as constraints, undesirable elements and characteristics to be excluded from the image file representing the custom sticker.

17. The system of claim 16, wherein dynamically generating the second prompt further comprises:
dynamically generating the second prompt using the second predefined prompt template to include one or more examples, each example comprising a textual description of a sticker paired with an image file representing a sticker, as desired output.

18. The system of claim 11, wherein the generative language model is a Large Language Model (LLM) accessible to the server over a network.

19. The system of claim 11, wherein the generative image model is selected from the group consisting of:
a Generative Adversarial Network (GAN), utilizing competing neural networks to generate image files with images that are visually similar to authentic images based on text-based prompts;
a Variational Autoencoder (VAE), using a probabilistic approach to generate image files with images by encoding inputs into a latent space and then decoding them back to outputs, guided by text-based prompts; and
a Transformer-based model, designed for image generation by processing text-based prompts through self-attention mechanisms to produce image files with images.

20. A system for generating a custom sticker in response to a request from a client device, the system comprising:
means for receiving the request from the client device, the request including text input into a message input field of a chat interface presented at the client device; and
means for processing the request by:
dynamically generating a first prompt based on the text received with the request using a first predefined prompt template, the first prompt including an instruction to a generative language model to interpret the text and generate, as output, a textual description of the custom sticker;
providing the first prompt to a generative language model, as input, and receiving from the generative language model, as output, the textual description of the custom sticker;
dynamically generating a second prompt to include the textual description of the custom sticker using a second predefined prompt template, the second prompt including an instruction to a generative image model to interpret the textual description of the custom sticker and generate, as output, an image file representing the custom sticker;
providing the second prompt to the generative image model, as input, and receiving from the generative image model, as output, an image file representing the custom sticker; and
sending the image file representing the custom sticker to the client device.
